(19) United States
(12) Patent Application Publication
(10) Pub. No.: US 2013/0191814 A1
(43) Pub. Date: Jul. 25, 2013

(54) TEST SCENARIO GENERATION METHOD, TEST SCENARIO GENERATION SYSTEM, AND TEST SCENARIO GENERATION PROGRAM

(71) Applicants: Akihiro Fujii, Yokohama (JP); Masahiro Kudou, Fujisawa (JP)

(72) Inventors: Akihiro Fujii, Yokohama (JP); Masahiro Kudou, Fujisawa (JP)

(73) Assignee: Hitachi, Ltd., Tokyo (JP)

(21) Appl. No.: 13/811,756

(22) PCT Filed: Jul. 27, 2010
(86) PCT No.: PCT/JP2010/062621

§ 371 Date: Apr. 5, 2013

(51) Int. Cl. G06F 11/36

(52) U.S. Cl. CPC G06F 11/3684
USPC 717/124

(57) ABSTRACT

A computer holds a web content and a test scenario to operate the web content, extracts a common part and a different part between a first web content before update and a second web content after update, extracts a test scenario corresponding to the common part, of a first test scenario to operate the first web content, and connects the test scenario corresponding to the extracted common part and a newly generated test scenario corresponding to the extracted different part and thus generates a second test scenario to operate the second web content.

### TECHNICAL FIELD

The present invention relates to a test scenario generation method and particularly to a method for generating a test scenario to test a web content.

### BACKGROUND ART

Recently, various services are realized by web applications. Services provided by web applications are convenient in that the user can use the services simply on the corresponding browser. Therefore, such services are used in a number of circumstances such as B2B (business to business) and B2C (business to consumer).

Against that background, a number of similar services are provided by web applications, intensifying competition among services. Therefore, it is important to develop a web application early and quickly make the web application available to the public. Thus, a technique for reducing the development period by automatically carrying out a time-consuming testing process in the development of a web application is demanded.

As a related-art technique for such testing, there is a method in which software to conduct testing automatically is installed in a web browser or testing machine and a script file including the content of the testing is created from the beginning by programming. Moreover, the created script file is executed by the web browser or testing machine in which the software is installed.

However, according to this related-art technique, since the contents of all tests are created by humans, not all test cases where the testing needs to be implemented may be listed because of a lapse of memory or the like. In such cases, the web application is made available to the public without sufficient implementation of the testing, thus causing a problem. There also is a problem that results of tests are not displayed visibly to the test performer and are outputted as a text-based log.

Moreover, many more tools of web applications are to test requests sent to the server side, of operation processes carried out on the web browser. Therefore, in a test to check how a screen is ultimately shown on the web browser, a method in which a person manually operates the GUI displayed on the web browser and then visually checks the output screen is generally used.

Also, PTL 1 discloses a technique in which software of a GUI which is different from a GUI displayed on a web browser and operates on a certain OS is automatically operated to conduct testing. According to the technique disclosed in the PTL 1, a file representing a GUI screen can be written in advance and a script file to enable automatic testing of the GUI screen can be created.

However, the technique disclosed in PTL 1 has a problem that the technique can be applied to the software of a GUI operating directly on the OS but cannot be applied to a GUI operating on the web browser. There also is a problem that what operation is being carried out at the time of testing cannot be visually checked.

Meanwhile, PTL 2 discloses a technique for recording and reproducing an operation carried out on a web browser. According to the technique disclosed in PTL 2, an operation carried out on a web browser can be recorded and reproduced by inserting a program using JavaScript onto the web browser. However, the testing of a GUI on the web browser needs to be executed from the beginning and the testing process cannot be cut though test results can be visually checked.

### CITATION LIST

### Patent Literature

PTL 1: JP-A-2007-323573
PTL 2: JP-A-2008-117093

### SUMMARY OF INVENTION

### Technical Problem

The problems that the invention is to solve are the following two.

A first problem is to cut the testing process in the development of a new web content, by using an existing web content that is already available to the public. In the related-art technique, a script file for automatic testing, used to test an existing web content, is manually re-edited in order to test a new web content. Therefore, there is a problem that the testing process to create the script file takes a long period.

A second problem is to prevent omission of any test on a web content. There are three points (normal, abnormal, and boundary value condition) employed in testing. A number of elements (for example, forms of GUI) are used in a web content. The test performer employs one or a combination of at least two, of normal, abnormal, and boundary value condition with respect to the individual elements and thus generates test cases for the web content. Then, the test performer generates script files corresponding to the individual test cases that are generated.

Therefore, many test cases exist for a web content that is made available to the public and the test cases derived from the web content that is made available to the public tend to include test cases that cannot be listed appropriately. Consequently, there is a problem that a new web content has low quality even after testing.

### Solution to Problem

According to an exemplary aspect of the invention, a test scenario generation method for a computer which holds, in a storage medium, a web content and a test scenario to operate the web content, includes: causing the computer to extract a common part and a different part between a first web content before update in the storage medium and a second web content after update; causing the computer to extract a test scenario corresponding to the common part, of a first test scenario to operate the first web content, from the storage medium in which the first test scenario is stored; and causing the computer to connect the test scenario corresponding to the extracted common part and a newly generated test scenario corresponding to the extracted different part and thus generate a second test scenario to operate the second web content.

### Advantageous Effects of Invention

According to an embodiment of the invention, the number of testing processes required for the development of a web content that is created based on an existing web content is reduced, and the quality of the created web content is improved.

### BRIEF DESCRIPTION OF DRAWINGS

FIG. 1A is a block diagram showing a main storage unit provided in a client device according to an embodiment of the invention.

FIG. 1B is a block diagram showing a program included in the main storage unit of the client device according to the embodiment of the invention.

FIG. 1C is a block diagram showing an auxiliary storage unit provided in the client device according to the embodiment of the invention.

FIG. 1D is a block diagram showing a main storage unit provided in a server device according to the embodiment of the invention.

FIG. 1E is a block diagram showing an auxiliary storage unit provided in the server device according to the embodiment of the invention.

FIG. 1F is a block diagram showing an auxiliary storage unit provided in the server device according to the embodiment of the invention.

FIG. 2 is an explanatory view showing an example of a web content held in the auxiliary storage unit according to the embodiment of the invention.

FIG. 3 is an explanatory view showing an operation log held in the auxiliary storage unit according to the embodiment of the invention.

FIG. 4 is a sequence diagram showing processing to record an operation carried out on a web browser and processing to store a recording result in the server device according to the embodiment of the invention.

FIG. 5 is a flowchart showing processing to acquire a web content whose operation is recorded according to the embodiment of the invention.

FIG. 6 is a flowchart showing processing to record an operation at the time of executing a web content according to the embodiment of the invention.

FIG. 7 is an explanatory view showing the relation between operation and operation log according to the embodiment of the invention.

FIG. 8 is a flowchart showing processing to store an operation log in the server device according to the embodiment of the invention.

FIG. 9 is a sequence diagram showing processing to automatically generate a test case for an updated web content according to the embodiment of the invention.

FIG. 10 is an explanatory view showing a screen to input a web content for which a test case is generated, into the client device according to the embodiment of the invention.

FIG. 11 is a flowchart showing content analysis processing according to the embodiment of the invention.

FIG. 12A is a flowchart showing processing to generate a test case according to the embodiment of the invention.

FIG. 12B is a flowchart showing processing to generate a test case according to the embodiment of the invention.

FIG. 13 is an explanatory view showing a test case definition file according to the embodiment of the invention.

FIG. 14 is an explanatory view showing a screen to modify a test case according to the embodiment of the invention.

FIG. 15 is an explanatory view showing a screen to modify a test case value according to the embodiment of the invention.

FIG. 16 is a flowchart showing processing to store a test case modified by the client device, and an operation log, according to the embodiment of the invention.

FIG. 17 is a sequence diagram showing processing to reproduce a web content held in the server device and an operation log corresponding to the web content, in the client device according to the embodiment of the invention.

FIG. 18 is a flowchart showing processing to acquire information to reproduce an operation according to the embodiment of the invention.

FIG. 19 is a flowchart showing processing to reproduce an operation according to the embodiment of the invention.

### DESCRIPTION OF EMBODIMENTS

Hereinafter, an embodiment of the invention will be described in detail with reference to the drawings.

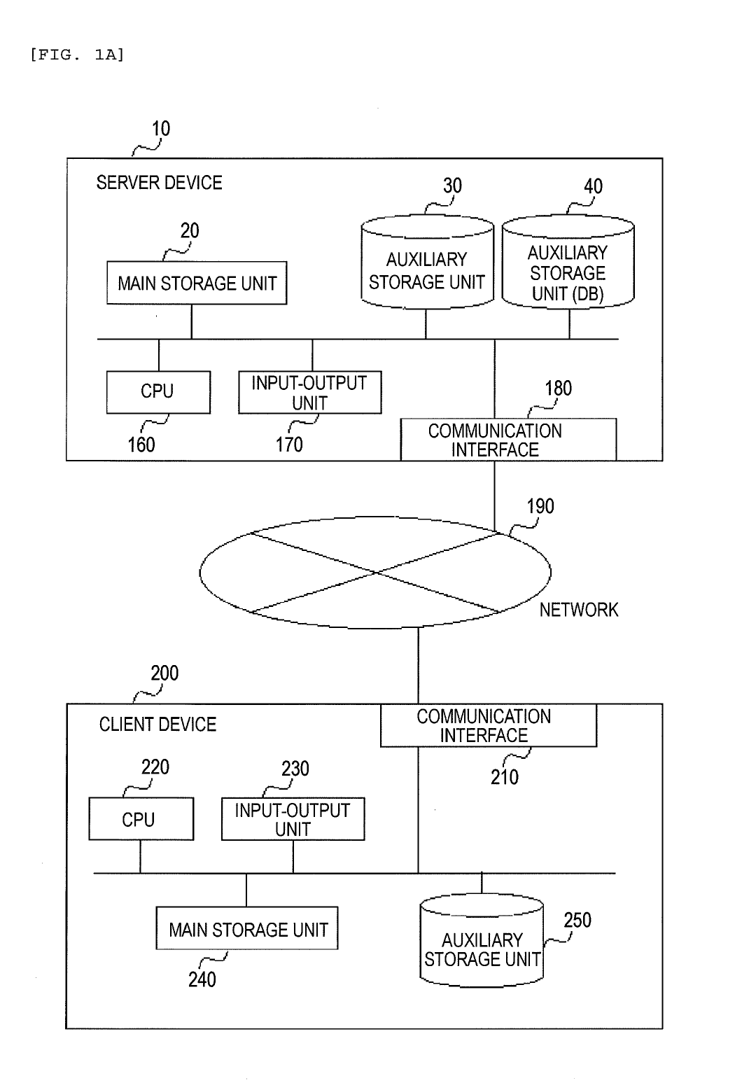

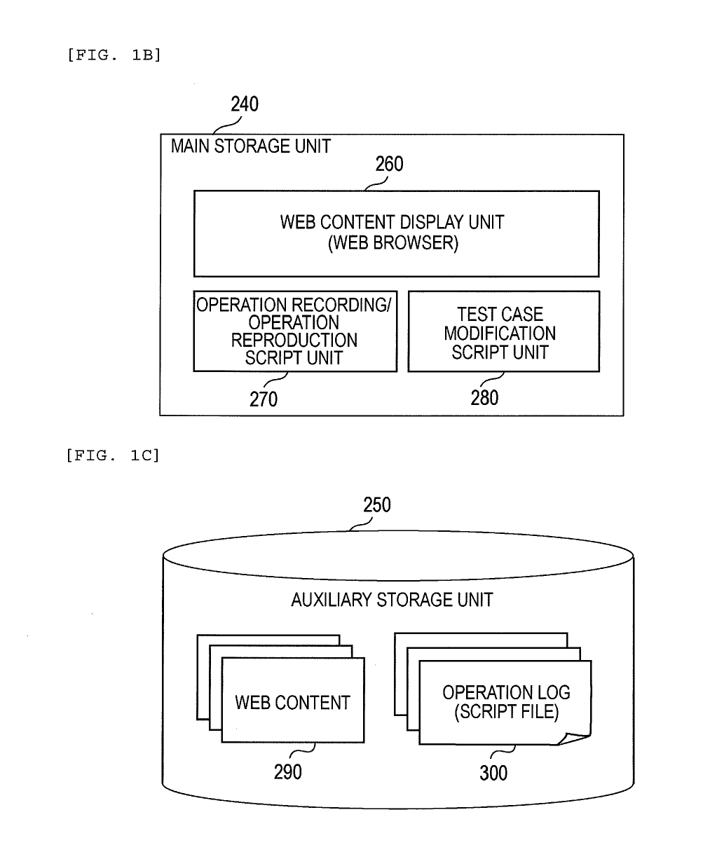

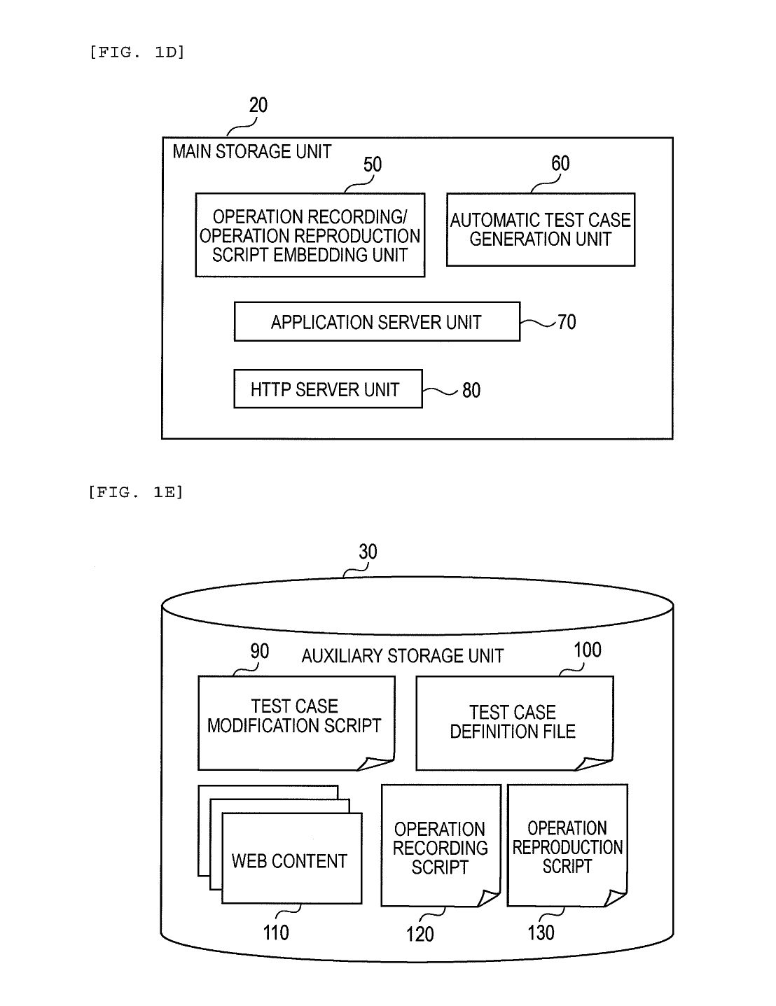

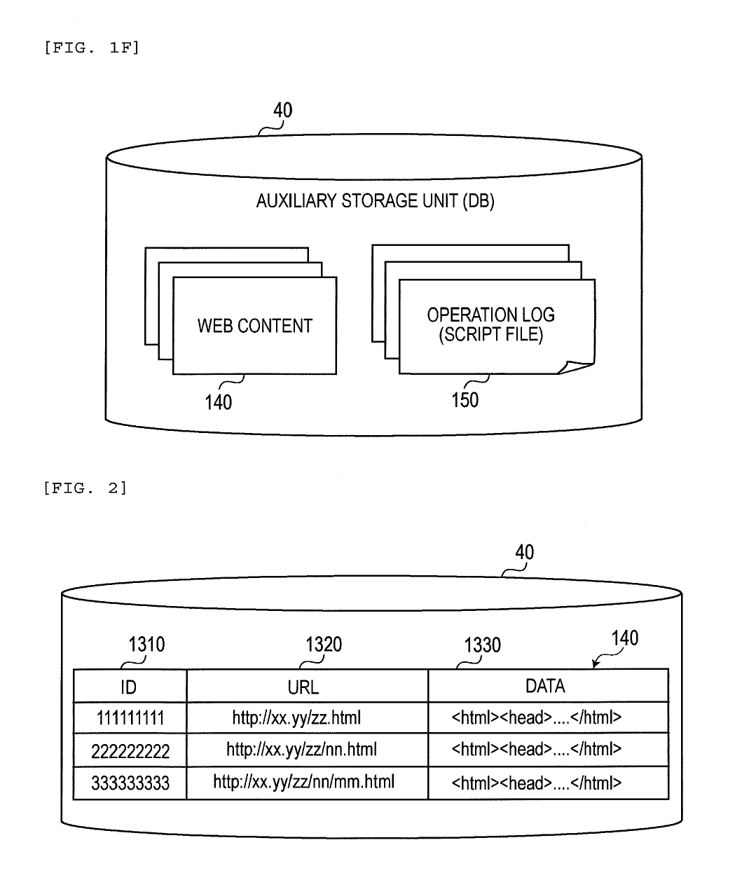

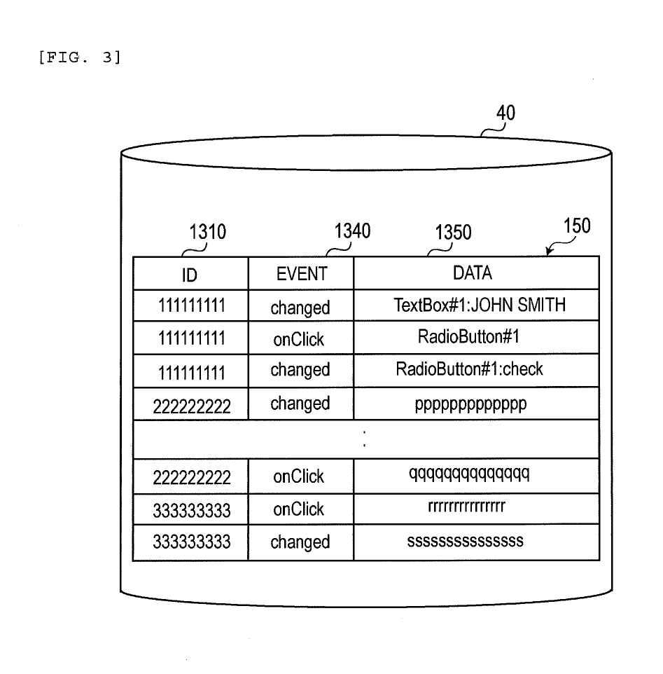

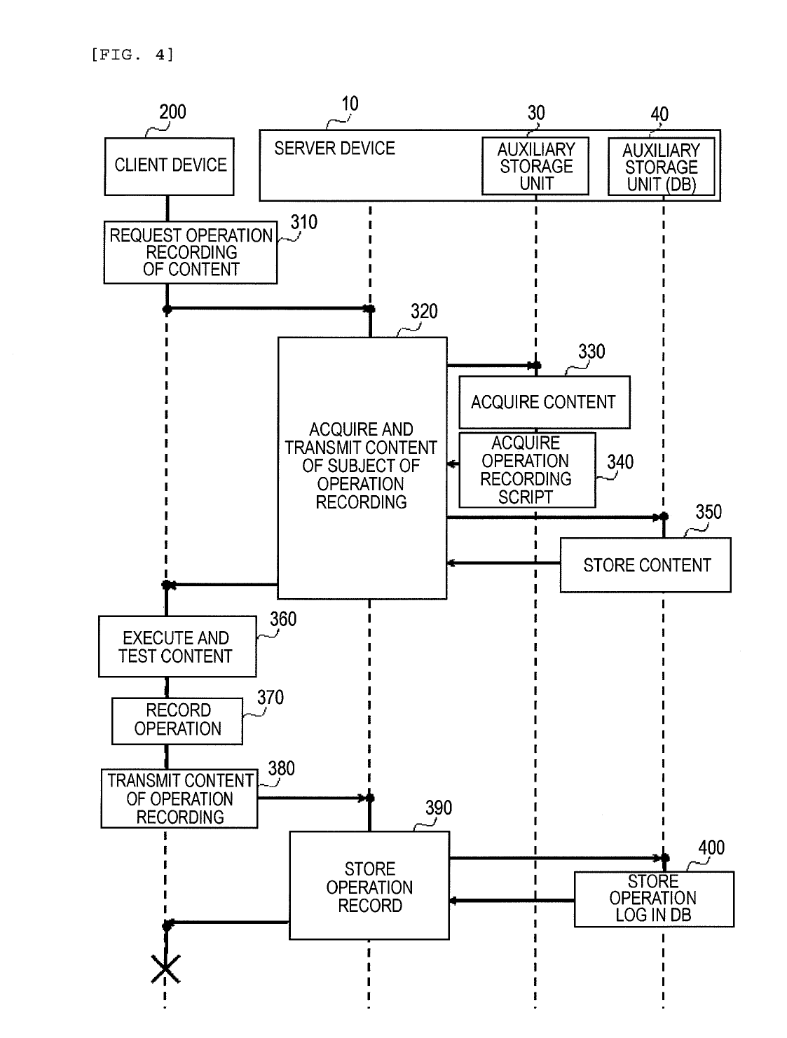

FIG. 1A is a block diagram showing the configuration of an automatic test case generation system for a web screen according an embodiment of the invention.

The automatic test case generation system according to the embodiment of the invention includes a client device 200, a server device 10, and a network 190. The client device 200 is a device used by a test performer. The server device 10 automatically generates a test case for a web screen in accordance with a request sent from the client device 200. The client device 200 and the server device 10 are included in computer systems connected via the network 190.

The client device 200 is connected to the network 190 via a communication interface 210. The server device 10 is connected to the network 190 via a communication interface 180. The network 190 is a communication path capable of transferring data and may be a LAN (local area network) using TCP/IP, Ethernet, the internet, or a wireless communication network or the like.

### (Configuration of Client Device 200)

The client device 200 is a computer having a CPU (central processing unit) 220, a main storage unit (memory) 240, an input-output unit 230, the communication interface 210, and an auxiliary storage unit 250. Each element provided in the client device 200 is connected by an internal bus.

The CPU 220 is an arithmetic unit which executes a program held in the main storage unit 240. The auxiliary storage unit 250 holds data generated by the execution of a program or data used for a program. The input-output unit 230 is a device such as a keyboard, mouse or display unit which provides a user interface.

FIG. 1B is a block diagram showing a program included in the main storage unit 240 of the client device 200 according to the embodiment of the invention.

The main storage unit 240 holds a web browser (web content display unit) 260, an operation recording/operation reproduction script unit 270, and a test case modification script unit 280. The CPU 220 is an arithmetic unit which executes the programs of the web browser 260, the operation recording/operation reproduction script unit 270 and the test case modification script unit 280 stored in the main storage unit 240.

FIG. 1C is a block diagram showing the auxiliary storage unit 250 provided in the client device 200 according to the embodiment of the invention.

The auxiliary storage unit 250 is a storage unit which holds a web content 290 and an operation log (script file) 300 described above.

The web browser 260 has a function of outputting content data transmitted from the server device 10 and received by the client device 200, to the display unit. The received content data is stored in the web content 290 held in the auxiliary storage unit 250.

The operation recording/operation reproduction script unit 270 has a function of recording and reproducing an operation carried out on the web browser 260 by the test performer when the test performer executes a script file included in the content data transmitted from the server device 10 and received by the client device 200, and a function of acquiring and recording the operation log 300 from the server device 10. In this embodiment, a JavaScript file is employed as the script file.

The test case modification script unit 280 has a function of modifying an operation log 150, described later, which is transmitted from the server device 10 and received by the client device 200. The test case modification script unit 280 also has a function of storing the operation log 150 modified by the test case modification script unit 280 into the operation log 300 held in the auxiliary storage unit 250, and a function of transmitting the operation log 300 to the server device 10.

### (Configuration of Server Device 10)

The server device 10 is a computer having a CPU 160, a main storage unit 20, an auxiliary storage unit 30, an auxiliary storage unit 40, an input-output unit 170, and the communication interface 180. Each element provided in the server device 10 is connected by an internal bus. The CPU 160 is an arithmetic unit which executes a program held in the main storage unit 20.

FIG. 1D is a block diagram showing the main storage unit 20 provided in the server device 10 according to the embodiment of the invention.

The main storage unit 20 holds programs such as an operation recording/operation reproduction script embedding unit 50, an automatic test case generation unit 60, an application server unit 70, and an HTTP server unit 80. The main storage unit 20 also has a storage area in which data can temporarily be stored.

FIG. 1E is a block diagram showing the auxiliary storage unit 30 provided in the server device 10 according to the embodiment of the invention.

The auxiliary storage unit 30 is a storage medium which holds a web content 110, an operation recording script 120, an operation reproduction script 130, a test case modification script 90, and a test case definition file 100.

The web content 110 is, for example, a document file described in HTML (hyper text markup language). With the web content 110, a screen that can be operated by the test performer is displayed on the web browser 260.

The operation recording script 120 is, for example, a document file described in JavaScript. The operation recording script 120 has a function of storing an operation carried out on the web browser 260 into the auxiliary storage unit 250 of the client device 200 as the operation log 300. The operation recording script 120 also has a function of storing an operation carried out on the web browser 260 into the operation log 150 held in the auxiliary storage unit 40 of the server device 10.

The operation reproduction script 130 is, for example, a document file described in JavaScript. The operation reproduction script 130 has a function of reproducing the content of the operation log 150 held in the auxiliary storage unit 40 of the server device 10, on the web browser 260 of the client device 200.

The test case modification script 90 is a document file described in JavaScript. The test case modification script 90 has a function of modifying the operation log 300 held in the auxiliary storage unit 250 provided in the client device 200 or the operation log 150 sent by the server device 10. The test case modification script 90 also has a function of storing the modified operation log 300 or operation log 150 into the operation log 300 of the server device 10.

FIG. 1F is a block diagram showing the auxiliary storage unit 40 provided in the server device 10 according to the embodiment of the invention.

The auxiliary storage unit 40 is a storage medium which holds a web content 140 and the operation log (script file) 150. The auxiliary storage unit 40 according to this embodiment holds data as a database.

The web content 140 refers to a web content whose operation on the web browser 260 is recorded. The web content 140 is stored as character string information in the auxiliary storage unit 40. The operation log 150 is information indicating the operation corresponding to the web content 140. The operation log 150 is an executable script file.

The web content 140 and the operation log 150 correspond to each other. The web content 140 is given a univocal identifier.

The web content 110 held in the auxiliary storage unit 30 is the original and corresponds to the web content 140 held in the auxiliary storage unit 40. After updating the content of the web content 110, the test performer may record an operation of the web content after update or test the web content after update in some cases. Therefore, a web content used for operation recording or testing in the client device 200 is stored as the web content 140 held in the auxiliary storage unit 40.

### (Web Content 140 and Operation Log 150)

FIG. 2 is an explanatory view showing an example of the web content 140 held in the auxiliary storage unit 40 according to the embodiment of the invention.

The web content 140 includes an identifier 1310, a URL 1320, and data 1330. The identifier 1310 is an identifier that is univocally given to each web content 140.

The URL 1320 is a name indicating the web content 140 and may include a character string indicating a resource (server, folder or the like) which stores the web content 140. The data 1330 is the content of the web content 140, and a specific script is stored therein. The data 1330 shown in FIG. 2 is an example in the case where the web content 140 is described in HTML.

The web content 140 provided in the server device 10 and the web content 290 provided in the client device 200 include the same content.

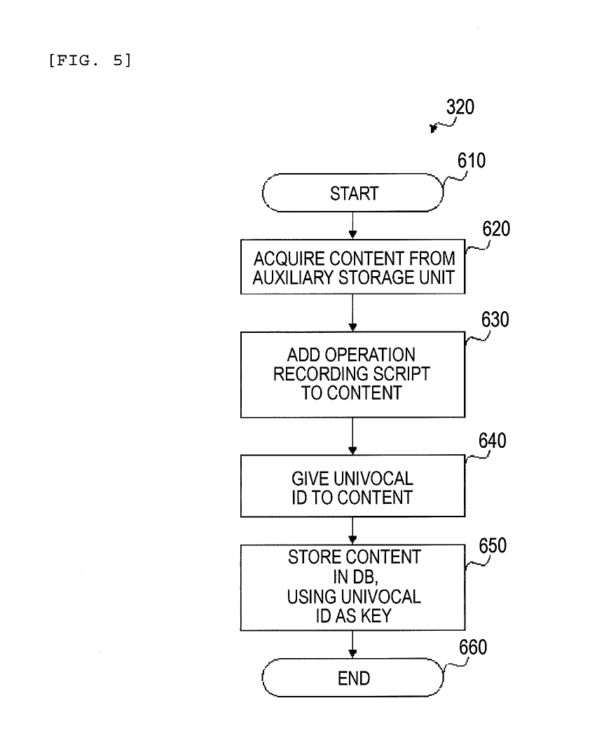

FIG. 3 is an explanatory view showing the operation log 150 held in the auxiliary storage unit 40 according to the embodiment of the invention.

The operation log 150 includes the identifier 1310, an event 1340, and data 1350. The identifier 1310 included in the operation log 150 corresponds to the 1310 included in the web content 140. The row with the same identifier 1310 indicates the operation in the same web content 140.

The event 1340 indicates the content of an operation carried out in a form included in the web content 140 when the web content 140 is executed. The data 1350 includes a form to be the subject of the event 1340, or an inputted value or the like. For example, if the event 1340 of the operation log 150 is “onClick” and the data 1350 is “RadioButton”, the operation log 150 indicates that a radio button is clicked on by the operation.

Here, the form refers to the subject of an operation, for example, a list box, text box or dialog box included in the web content in the case where the web content is created in HTML.

The operation log 150 provided in the server device 10 and the operation log 300 provided in the client device 200 include the same content.

### (Application Server Unit 70 and HTTP Server Unit 80)

The HTTP server unit 80 receives an HTTP request sent from the client device 200 via the network 190. After that, the HTTP server unit 80 extracts a request or data from the client device 200 included in the received HTTP request and sends the extracted request or data to the application server unit 70.

Also, after processing by the application server unit 70 is completed, the HTTP server unit 80 generates an HTTP response by inserting a processing result received from the application server unit 70 into the HTTP request sent from the client device 200, and sends the generated HTTP response to the client device 200 via the network 190.

The application server unit 70 sends a request or data to the operation recording/operation reproduction script embedding unit 50 or the automatic test case generation unit 60 in accordance with the content of the HTTP request (request) sent from the client device 200, and receives the result thereof.

If the request sent from the client device 200 is a request for processing to carry out operation recording and/or operation reproduction, or a request to store an operation log or the like, the application server unit 70 delivers the request to the operation recording/operation reproduction script embedding unit 50.

If the request sent from the client device 200 is an request to record an operation carried out on the web browser 260 in the client device 200, the operation recording/operation reproduction script embedding unit 50 acquires the web content 110 and the operation recording script 120 from the auxiliary storage unit 30. Then, after carrying out processing, described later, the operation recording/operation reproduction script embedding unit 50 sends the web content 110 and the operation recording script 120 as the result of processing to the application server unit 70.

Meanwhile, if the request sent from the client device 200 is a request to reproduce an operation carried out on the web browser 260 in the client device 200, the operation recording/operation reproduction script embedding unit 50 acquires the operation reproduction script 130 held in the auxiliary storage unit 30 and the web content 140 and the operation log 150 held in the auxiliary storage unit 40. Then, after carrying out processing which will be described later, the operation recording/operation reproduction script embedding unit 50 sends the acquired operation reproduction script 130, web content 140 and operation log 150 as the result of processing to the application server unit 70.

If the request sent from the client device 200 includes a request to automatically generate a test case, the application server unit 70 sends the request to the automatic test case generation unit 60. When the automatic test case generation unit 60 receives the request from the application server unit 70, the automatic test case generation unit 60 acquires the web content 140 and the operation log 150 held in the auxiliary storage unit 40.

Then, after carrying out processing which will be described later, the automatic test case generation unit 60 sends the acquired web content 140 and operation log 150 as the result of processing to the application server unit 70. Moreover, the application server unit 70 sends the acquired web content 140 and operation log 150 to the client device 200 via the HTTP server unit 80.

The application server unit 70 and the HTTP server unit 80 according to this embodiment constantly send the request transmitted from the client device 200 to the operation recording/operation reproduction script embedding unit 50 or the automatic test case generation unit 60 and sends the result from the operation recording/operation reproduction script embedding unit 50 or the automatic test case generation unit 60 to the client device 200, as described above.

### (Outline of Automatic Test Case Generation Processing)

Hereinafter, an outline of automatic test case generation processing in the system of this embodiment will be described.

In the system of this embodiment, in order to automatically generate a test case, when the web content 290 is executed in the client device 200, the web operation log 300 related to a test carried out by the test performer is recorded and is held in advance in the auxiliary storage unit 40 of the server device 10.

Then, when the client device 200 transmits a request to generate a test case for the web content 290 after update to the server device 10, the server device 10 of this embodiment generates a new test case based on the operation log 150 that is held in advance, and sends the test case to the client device 200. The client device 200 modifies the test case that is sent, according to need, and sends a request to register the web content 290 (web content 140) corresponding to the modified test case to the server device 10.

Moreover, the client device 200 requests the server device 10 to automatically reproduce the operation. The server device 10 transmits the operation log 150 corresponding to the web content 140 (web content 290) to the client device 200 in accordance with the request by the client device 200. The client device 200 automatically reproduces the web content 290 based on the operation log 150 transmitted from the server device 10. Thus, the system of this embodiment can execute a dynamically generated test case.

Hereinafter, operation recording processing, automatic test case generation processing, and operation reproduction processing will be described.

### (Operation Recording Processing)

Hereinafter, processing to record an operation on the web browser 260 of the system of this embodiment will be described.

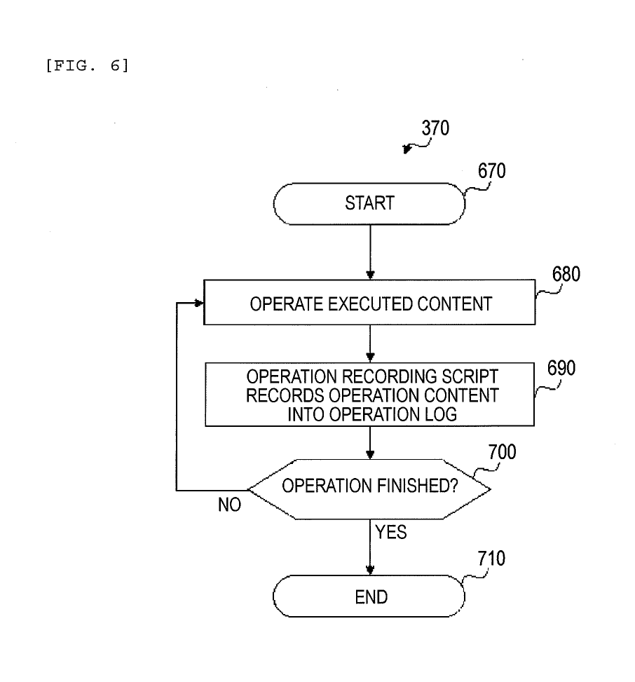

FIG. 4 is a sequence diagram showing the processing to record an operation carried out on the web browser 260 and processing to store the recording result in the server device 10 according to the embodiment of the invention.

When generating a test case for a specified web content, the test performer first records an operation of the time when a web content is executed on the web browser 260. The test performer sends a specific web content and a request to record an operation to the server device 10 from the client device 200 (310).

If the web content whose operation is recorded is stored in advance in the web content 110 of the auxiliary storage unit 30, the client device 200 may send information (file name, identifier or the like) indicating the web content whose operation is recorded, to the server device 10 in a sequence process 310. Meanwhile, if the web content whose operation is recorded is not stored in the auxiliary storage unit 250 of the client device 200, the web content whose operation is recorded may be stored in the auxiliary storage unit 250 in the sequence process 310.

The server device 10 receives the specific web content or the information indicating the web content and the request to record an operation, from the client device 200 via the HTTP server unit 80 and the application server unit 70, as described above. Since the request transmitted from the client device 200 is a request to record an operation, the application server unit 70 sends the received request and the like to the operation recording/operation reproduction script embedding unit 50.

After that (320), if the web content 110 corresponding to the web content that is sent is held in the auxiliary storage unit 30, the operation recording/operation reproduction script embedding unit 50 acquires the web content 110 corresponding to the web content or the information indicating the web content sent from the client device 200 (330).

Then, the operation recording/operation reproduction script embedding unit 50 of the server device 10 acquires the operation recording script 120 held in the auxiliary storage unit 30 (340). After acquiring the web content 110 whose operation is recorded and the operation recording script 120, the operation recording/operation reproduction script embedding unit 50 adds the operation recording script 120 to the web content 110 acquired by the operation recording/operation reproduction script embedding unit 50.

Also, the operation recording/operation reproduction script embedding unit 50 gives a univocal identifier to the web content transmitted from the client device 200 or the web content 110 acquired from the auxiliary storage unit 30 and stores the web content into the web content 140 of the auxiliary storage unit 40 (350).

The identifier given in the sequence process 350 may be univocally given to the web contents 140 having the same file name. That is, the identifier may be univocally given to the web contents 140 of different versions but the same name, or may be given every version of the web content 140.

However, when the identifier is univocally given to the web contents 140 of different versions but the same name, the version of the web content 140 to be sent to the client device 200 is set in advance in the server device 10 by the manager or the like. For example, the server device 10 is set so as to constantly transmit the web content 140 of the latest version to the client device 200.

By the sequence processes 330 and 340, the server device 10 can transmit the web content 140 whose operation is recorded, together with the operation recording script 120, to the client device 200.

After the sequence processes 330, 340 and 350, the server device 10 transmits the web content 140 whose operation is recorded, the operation recording script 120 and the identifier which univocally identifies the web content 140 to the client device 200. The server device 10 transmits the web content 140 whose operation is recorded and the like to the client device 200 via the application server unit 70 and the HTTP server unit 80, as described above.

After receiving the web content 140, the operation recording script 120 and the identifier which univocally identifies the web content 140 from the server device 10, the client device 200 stores the web content 140 sent from the server device 10 together with the received identifier into the web content 290 of the auxiliary storage unit 250.

Then, the client device 200 executes the web content 290 whose operation is recorded, on the web browser 260 (360). The operation recording/operation reproduction script unit 270 executes the operation recording script 120 and thereby records an operation that is carried out when the test performer tests the web content 290 (370). The client device 200 stores an operation log acquired in the sequence process 370 into the operation log 300.

The client device 200 transmits the operation log 300 acquired in the sequence process 370, the identifier of the web content 290 and a request to store the operation log 300 to the server device 10 (380).

The server device 10 receives the operation log 300, the identifier of the web content 290 and the request to store the operation log 300, sent from the client device 200, via the application server unit 70 and the HTTP server unit 80, as described above. After that (390), the operation recording/operation reproduction script embedding unit 50 stores the received operation log 300 into the operation log 150 of the auxiliary storage unit 40, based on the identifier of the web content 290 which is similarly received (400). Specifically, the received operation log 300 is stored in the operation log 150 corresponding to the web content 140 identified by the received identifier of the web content 290.

After that, the server device 10 transmits the result of processing to the client device 200. The result of processing includes the identifier of the web content 290 whose operation is recorded and information that the operation log 300 is stored. Thus, the web content 290 and the operation log 300 in the auxiliary storage unit 250 are synchronized with the web content 140 and the operation log 150 in the auxiliary storage unit 40.

As in the processing shown in FIG. 4, by acquiring in advance the operation log 150 of the web content before update, the client device 200 can acquire the operation log 150 that serves as a reference when the test performer creates a new test case for the web content after update.

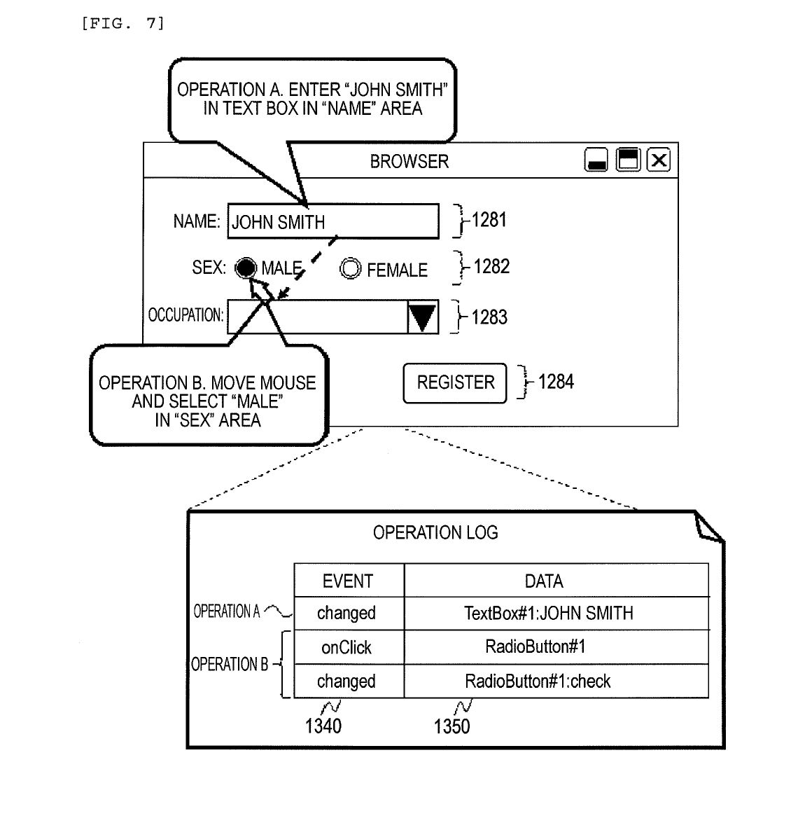

FIG. 5 is a flowchart showing processing to acquire a web content whose operation is recorded according to the embodiment of the invention.

FIG. 5 is a flowchart showing the step 320 shown in FIG. 4. With the processing shown in FIG. 5, the operation recording script 120 can be added to the web content 140 that is requested to be recorded by the client device 200.

After the sequence process 310 shown in FIG. 4, and after the specific web content or the information indicating the web content and the request to record an operation are received from the client device 200, the operation recording/operation reproduction script embedding unit 50 of the server device 10 starts the processing shown in FIG. 5 (610). The operation recording/operation reproduction script embedding unit 50 acquires the web content 110 corresponding to the web content requested by the client device 200, of the web contents 110 held in the auxiliary storage unit 30, using the web content or the information indicating the web content sent from the client device 200 (620).

After the step 620, the operation recording/operation reproduction script embedding unit 50 adds the operation recording script 120 similarly acquired from the auxiliary storage unit 30 to the acquired web content 110 (630). Then, the operation recording/operation reproduction script embedding unit 50 gives a univocal identifier to the web content 110 whose operation is recorded (640). The operation recording/operation reproduction script embedding unit 50 stores the web content 110 with the identifier into the web content 140 held in the auxiliary storage unit 40 (650).

After the step 650, the server device 10 sends the web content 110 whose operation is recorded, to the client device 200, and ends the processing (660).

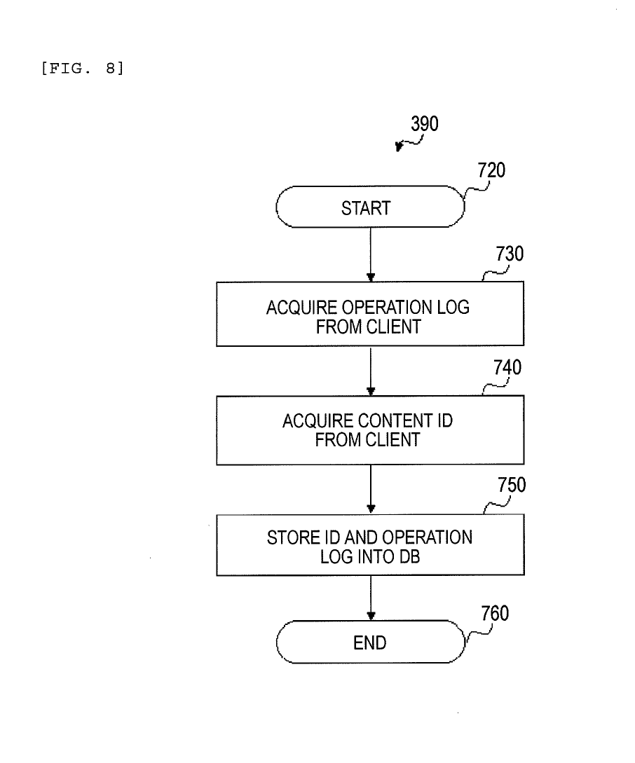

FIG. 6 is a flowchart showing processing to record an operation at the time of executing the web content 290 according to the embodiment of the invention.

FIG. 6 is a flowchart showing the sequence process 370 shown in FIG. 4. Here, processing to record the operation log 300 corresponding to an operation carried out by the test performer into the web content executed on the web browser 260 is shown.

When the web content 290 is executed in the sequence process 370 of FIG. 4, the processing shown in FIG. 6 is started (670). First, when the test performer operates the executed web content 290 (680), the operation recording/operation reproduction script unit 270 executes the operation recording script 120 and thus records the operation content in the operation log(script file) 300 (690).

Specifically, the operation recording/operation reproduction script unit 270 determines whether web content 290 is operated or not during the execution of the web content 290, using the operation recording script 120. When the web content 290 is operated, the operation recording/operation reproduction script unit 270 records the operation in the operation log 300.

The operation recording/operation reproduction script unit 270 also records the operation content in the operation log 300 as an executable script file. This is for the purpose of enabling reproduction of the operation content as the client device 200 executes the operation log 300 recorded by the operation recording/operation reproduction script unit 270.

The test performer then determines whether the operation on the web content 290 is finished or not (700). If the operation is not finished, the processing returns to the step 680. When the operation is finished, the processing ends (710).

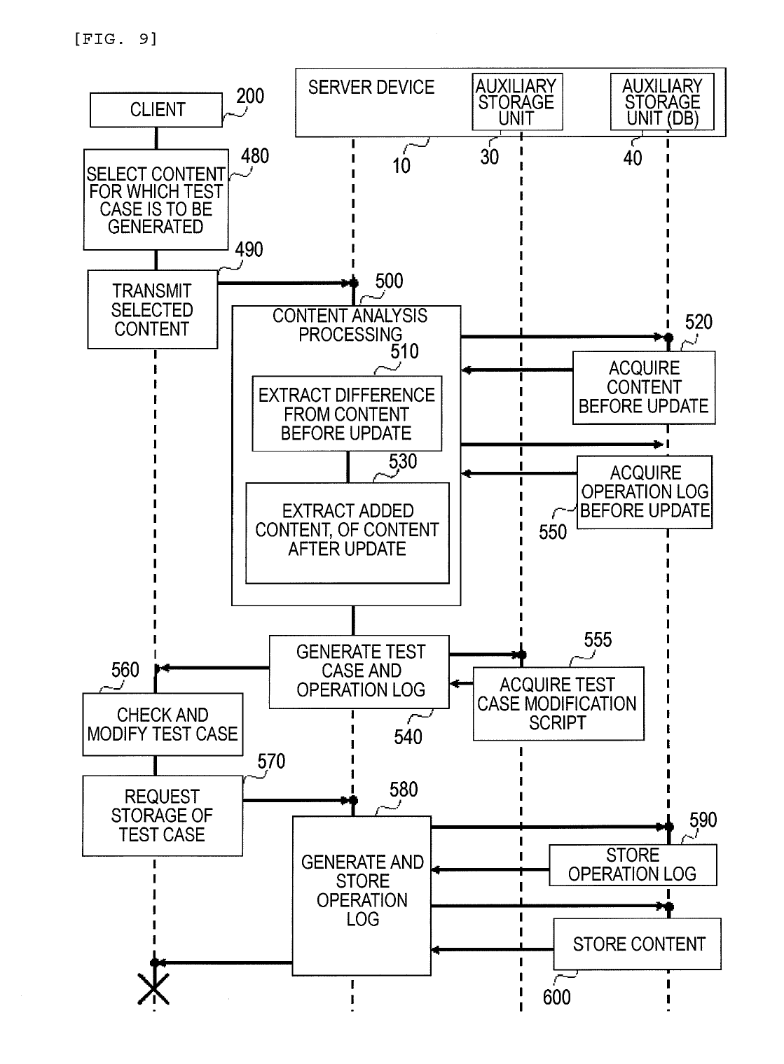

FIG. 7 is an explanatory view showing the relation between an operation and the operation log 300 according to the embodiment of the invention.

The operation recording/operation reproduction script unit 270 records the operation carried out by the test performer on the web browser 260 where the web content 290 is executed, into the operation log 300 in the sequence process 370 of FIG. 4.

FIG. 7 shows a screen displayed on the web browser 260 by the web content. The screen displayed on the web browser 260 shown in FIG. 7 includes a name area 1281, a sex area 1282, an occupation area 1283, and a registration area 1284. The name area 1281 is in the form of text box. The sex area 1282 is in the form of radio buttons. The occupation area 1283 is a list box area. The registration area 1284 is in the form of a button.

For example, when the test performer enters “JOHN SMITH” in the text box of the name area 1281 (operation A), the operation recording/operation reproduction script unit 270 records “changed” in the event 1340 of the operation log 300 and records “TextBox#1:JOHN SMITH” in the data 1350.

Moreover, for example, when the test performer moves the cursor to “MALE” of the radio buttons in the sex area 1282 and selects “MALE” (operation B), the operation recording/operation reproduction script unit 270 records “onClick” in the event 1340 and records “RadioButton” in the data 1350. Also, in the operation B, the operation recording/operation reproduction script unit 270 records “changed” in the event 1340 and records “RadioButton#1:check” in the data 1350.

FIG. 8 is a flowchart showing processing to store an operation log in the server device 10 according to the embodiment of the invention.

FIG. 8 is the processing shown in the sequence process 390 of FIG. 4. This processing is also the processing to store the operation log 300 sent from the client device 200 into the operation log 150 held in the auxiliary storage unit 40.

After receiving the operation log 300, the identifier identifying the web content 290 and the request to store the operation log 300, sent from the client device 200, the server device 10 starts the processing shown in FIG. 8 (720). After 720, the operation recording/operation reproduction script embedding unit 50 provided in the server device 10 acquires the operation log 300 and the identifier identifying the web content 290 sent from the client device 200 (730, 740) and stores the operation log 300 into the operation log 150 in such a way as to correspond to the web content 140 corresponding to the acquired identifier.

### (Automatic Test Case Generation Processing)

### (Outline)

The test performer transmits a request to automatically generate a test case and information (ID or the like) indicating a web content to be tested to the server device 10 via the web browser 260 provided in the client device 200. The HTTP server unit 80 of the server device 10 receives the request and the information indicating the web content, sent from the test performer.

After the request sent from the test performer is sent from the HTTP server unit 80 to the application server unit 70 and is further sent from the application server unit 70 to the automatic test case generation unit 60, the automatic test case generation unit 60 acquires the web content 140 and the operation log 150 held in the auxiliary storage unit 40. The automatic test case generation unit 60 then automatically generates a test case based on the acquired web content 140 and operation log 150 and also generates a script file corresponding to each test case. The automatic test case generation unit 60 then transmits the generated script file to the client device 200.

After that, the test performer modifies the script file corresponding to each test case sent from the server device 10, using the web browser 260 of the client device 200. Then, the client device 200 transmits the script file (operation log 300) modified by the test performer to the server device 10 and also transmits a request to store the transmitted operation log 300 into the auxiliary storage unit 40 provided in the server device 10.

The server device 10 receives a request to register the script file (operation log 300) into the auxiliary storage unit 40, sent by the client device 200, and stores the script file (operation log 300) into the operation log 150 held in the auxiliary storage unit 40 using the automatic test case generation unit 60. The server device 10 also stores the web content 110 for which the test case is automatically generated by the automatic test case generation unit 60, into the web content 140 held in the auxiliary storage unit 40.

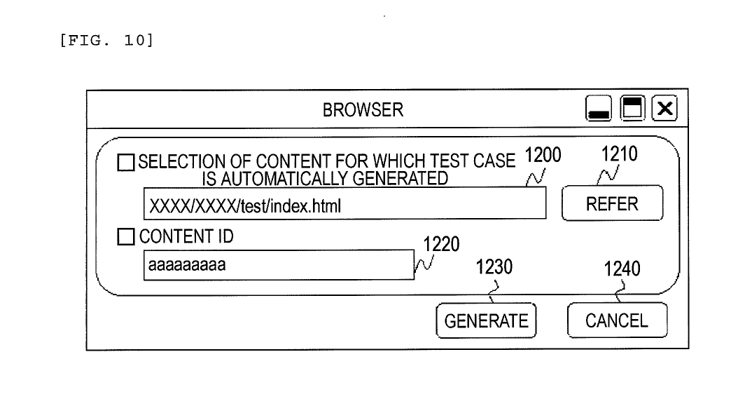

FIG. 9 is a sequence diagram showing processing to automatically generate a test case for an updated web content according to the embodiment of the invention. The processing is described in detail below.

The processing shown in FIG. 9 is carried out when the test performer updates a web content and creates a new test case for the updated web content, or when the test performer creates a new test case corresponding to a new web content, for example.

The test performer selects a web content for which a test case is to be generated and enters the selected web content, information indicating the web content and a request (for automatic generation) to automatically generate a test case for the selected web content to the client device 200 (480).

After that, the client device 200 transmits the web content, the entered information indicating the web content and the request to automatically generate a test case to the server device 10 (490).

Of the information sent to the server device 10 in the sequence process 490, the information indicating the web content may be any of the file name, URL name and identifier representing the web content. That is, in content analysis processing 500, later described, if the latest of the web contents 140 before update is constantly extracted, the information indicating the web content may be the file name or URL name. Also, in the content analysis processing 500, later described, if the web content 140 of a specific version of the web contents 140 before update is extracted, the identifier may be used as the information indicating the web content.

The server device 10 receives the web content for which a test case is to be automatically generated, the information indicating the web content and the request to automatically generate a test case, sent from the client device 200, via the HTTP server unit 80 and application server unit 70, as described above. After that, the automatic test case generation unit 60 of the server device 10 executes the content analysis processing 500.

The processing of sequence processes 510, 520, 530 and 550 described below, is executed when the web content for which a test case is to be generated is held in the server device 10 in advance. Therefore, the processing is not executed when a test case is generated for a new web content.

The server device 10 executes the content analysis processing 500, using the automatic test case generation unit 60. In the content analysis processing 500, the automatic test case generation unit 60 acquires the web content 140 before update of the web content sent thereto, of the web contents 140, based on the information indicating the web content that is sent thereto (520).

The server device 10 acquires the operation log 150 corresponding to the web content 140 acquired in the sequence process 420, in order to acquire a reference operation log to generate an operation log for each test case corresponding to the web content after update (550).

The server device 10 also compares the web content after update with the web content 140 before update, and extracts the difference (510). The server device 10 then extracts a changed or added part to the web content 140 before update, from the web content after update, and generates the extracted part as a web content (530).

Moreover, in the content analysis processing 500, if the web content 140 is given an identifier per version, the server device 10 gives a univocal identifier to the web content sent from the client device, that is, the web content after update.

After the content analysis processing 500, the automatic test case generation unit 60 of the server device 10 generates a test case for the web content after update, using the result of the comparison between the web content acquired in the content analysis processing 500 and the web content 140 and the operation log. Also, the automatic test case generation unit 60 generates an operation log corresponding to each test case (540). In the sequence process 540, the automatic test case generation unit 60 acquires the test case modification script 90 held in the auxiliary storage unit 30 (555).

A test case in this embodiment is information indicating a value entered in each form displayed on the web browser 260 by the web content 290, in a test. A test case includes a value (normal value) whereby a normal result is obtained when the value is entered in each form, a value (abnormal value) whereby an abnormal result is obtained, a boundary value between the normal value and the abnormal value, values before and after the boundary value, or the like.

An operation log is a script file indicating an operation to each form displayed on the web browser 260 by the web content, as described above. That is, an operation log in this embodiment is a script file executed in a test if the operation log is created based on a test case.

In this embodiment, an operation log is generated by a test case and a web content. That is, both the test case and the operation log hold the same content of test scenario. Therefore, a test case may be stored in the auxiliary storage unit 40 and the auxiliary storage unit 250, instead of the operation log 150 and the operation log 300, and an operation log may be generated from the test case when a test or reproduction or the like of an operation is carried out.

In the sequence process 540, the automatic test case generation unit 60 of the server device 10 adds the test case modification script 90 and the information indicating the web content such as the identifier generated in the content analysis processing 500 to the generated test case, and transmits the test case to the client device 200 via the application server unit 70 and the HTTP server unit 80, as described above.

In the sequence process 540, the server device 10 may send the generated operation log in addition to or instead of the test case, to the client device 200. That is, if the operation log is sent to the client device 200, the client device 200 may extract the test case included in the operation log that is sent thereto and may modify the extracted test case, in a sequence process 560, later described.

After the client device 200 receives the generated test case, the test case modification script 90 and the information indicating the web content, the client device 200 causes the test case modification script unit 280 to execute the test case modification script 90.

The test case modification script unit 280 displays a screen to modify the test case, using the web browser 260, and thereby allows the test performer to check and modify the test case sent from the server device 10 (560). In this way, in the system of this embodiment, the test performer arbitrarily changes the test case sent from the server device 10 and thus can create an appropriate test case according to the environment where a test is carried out.

After that, the client device 200 transmits the test case that is checked and modified and the information indicating the web content corresponding to the test case to the server device 10 in order to store the modified test case in the server device 10 (570).

After the server device 10 received the modified test case from the client device 200 via the HTTP server unit 80 and the application server unit 70 as described above (580), the automatic test case generation unit 60 generates an operation log from the modified test case. The generated operation log is stored in the operation log 150 of the auxiliary storage unit 40 (590). Then, the web content after update received in the content analysis processing 500 is stored in the web content 140 held in the auxiliary storage unit 40 (600).

If an identifier identifying the web content is given in the content analysis processing 500, the operation log and the web content are stored in the auxiliary storage unit 40, using the identifier identifying the web content as a key, in the sequence processes 590 and 600.

Moreover, after the sequence process 600, the server device 10 may transmit the operation log generated from the modified test case to the client device 200, and the client device 200 may store the operation log sent from the server device 10, the web content after update and the identifier identifying the web content into the auxiliary storage unit 250.

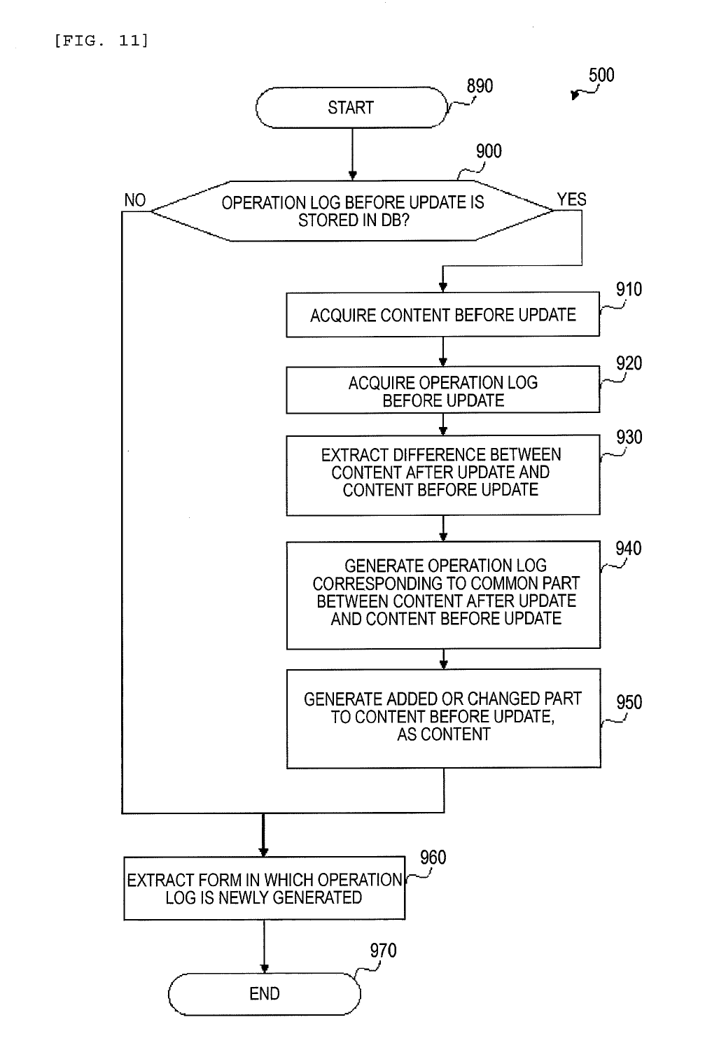

FIG. 10 is an explanatory view showing a screen to input a web content for which a test case is generated, to the client device 200, according to the embodiment of the invention.

The screen shown in FIG. 10 includes a web content designation area 1200, a reference button 1210, an identifier designation area 1220, a generation button 1230, and a cancel button 1240. The test performer writes the name or the like of the web content for which a test case is to be automatically generated, in the web content designation area 1200. If a new web content or a web content after update is stored in a folder provided in the client device 200, the folder name is acquired using the reference button 1210.

Meanwhile, if the web content for which a test case is to be generated is a web content generated by update, the test performer may enter the identifier of the web content before update into the area 1220. The test performer refers to the identifier 1310 included in the web content 290 held in the auxiliary storage unit 250, as the identifier of the web content. This is because the identifier 1310 included in the web content 290 is synchronized with the identifier of the web content 140 held in the auxiliary storage unit 40 since the identifier of the web content is sent from the server device 10 by the processing shown in FIG. 4 or the like.

The test performer enters a value in the web content designation area 1200 or the identifier designation area 1220 and operates the generation button 1230. Thus, the sequence process 480 shown in FIG. 9 is executed. The generation button 1230 is operated as this button is clicked on or the like.

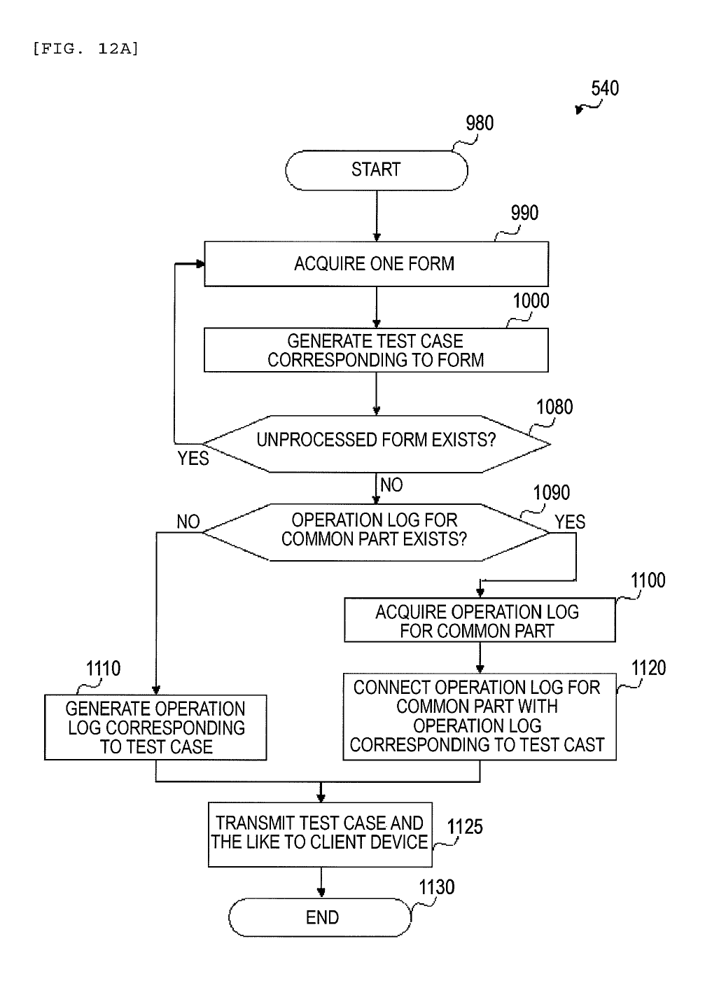

FIG. 11 is a flowchart showing the content analysis processing 500 according to the embodiment of the invention. FIG. 11 shows the content analysis processing of FIG. 9.

After the new web content or the web content after update, the information indicating the web content and the request to automatically generate a test case are sent from the client device 200 in the sequence process 490, the server device 10 starts the processing shown in FIG. 11 (890). The automatic test case generation unit 60 provided in the server device 10 determines whether the web content 140 before update corresponding to the web content sent from the client device 200 is stored in the auxiliary storage unit 40 or not (900). If the web content 140 before update is not stored in the auxiliary storage unit 40, the web content sent from the client device 200 is a new web content. Therefore, the automatic test case generation unit 60 shifts to a step 960.

If the web content 140 before update is stored in the auxiliary storage unit 40, the web content sent from the client device 200 is already test before and the operation log 150 is stored in the auxiliary storage unit 40. Therefore, the automatic test case generation unit 60 shifts to a step 910. The automatic test case generation unit 60 acquires the web content 140 before update held in the auxiliary storage unit (910). The automatic test case generation unit 60 also acquires the operation log 150 corresponding to the web content 140 of the version before update, held in the auxiliary storage unit 40 (920).

The steps 910 and 920 are equivalent to the sequence processes 520 and 550 shown in FIG. 9.

After the step 920, the automatic test case generation unit 60 extracts the difference between the web content after update sent from the client device 200 and the web content 140 acquired in the step 910, that is, the web content before update (930). In the step 930, the automatic test case generation unit 60 extracts an added or changed part to the web content before update, and a part that is deleted from the web content before update and does not exist in the web content after update, from the web content after update, as a difference.

After the step 930, the automatic test case generation unit 60 acquires a common part between the web content before update and the web content after update and generates an operation log corresponding to the common part, based on the operation log 150 acquired in the step 920 (940). This is because if the web contents are the same, the corresponding operation logs are the same, too. The automatic test case generation unit 60 stores the generated operation log corresponding to the common part into a temporary storage area or the like provided in the main storage unit 20 or the like.

After the step 940, the automatic test case generation unit 60 generates the added or changed part to the web content before update, of the difference extracted in the step 930, as a web content to be added to the common part (950). This is because a web content whose operation log needs to be newly generated is generated by the update. The part deleted from the web content before update in the steps 940 and 950 is not included in the web content whose operation log needs to be newly generated.

After the step 900 or the step 950, the automatic test case generation unit 60 extracts a form included in the added web content in order to generate an operation log corresponding to the added web content (960).

Specifically, if the processing directly shifts from the step 900 to the step 960, the automatic test case generation unit 60 in the step 960 extracts the form from the new web content sent from the client device 200. If the processing shifts from the step 950 to the step 960, the automatic test case generation unit 60 in the step 960 extracts the form from the web content added to the common part, generated in the step 950.

By the processing of the step 960, the automatic test case generation unit 60 can divide forms in which an operation log is generated. After the step 960, the automatic test case generation unit 60 ends the content analysis processing 500 (970).

The processing of the step 930 shown in FIG. 11 is equivalent to the sequence process 510 shown in FIG. 9. The processing of the steps 940 and 950 shown in FIG. 11 is equivalent to the sequence process 530 shown in FIG. 9.

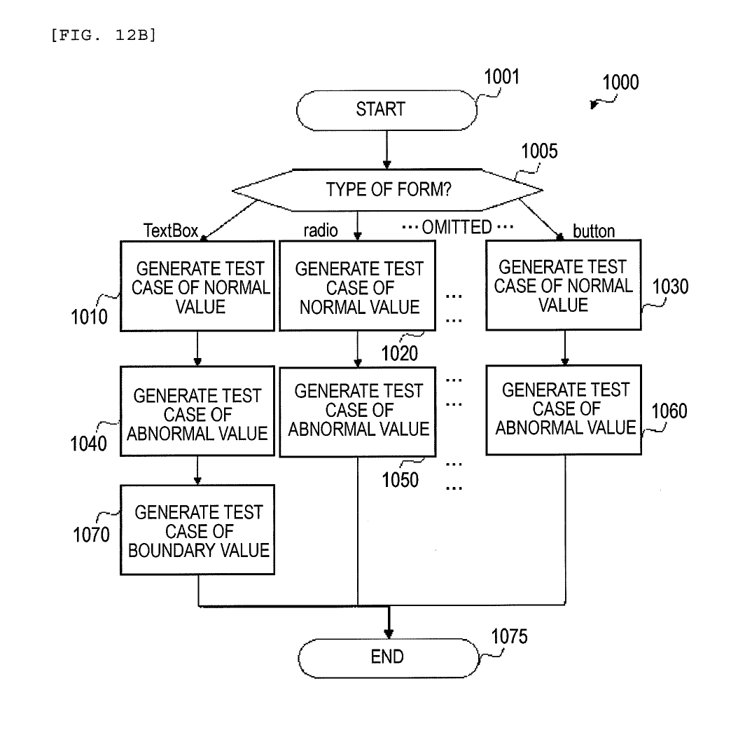

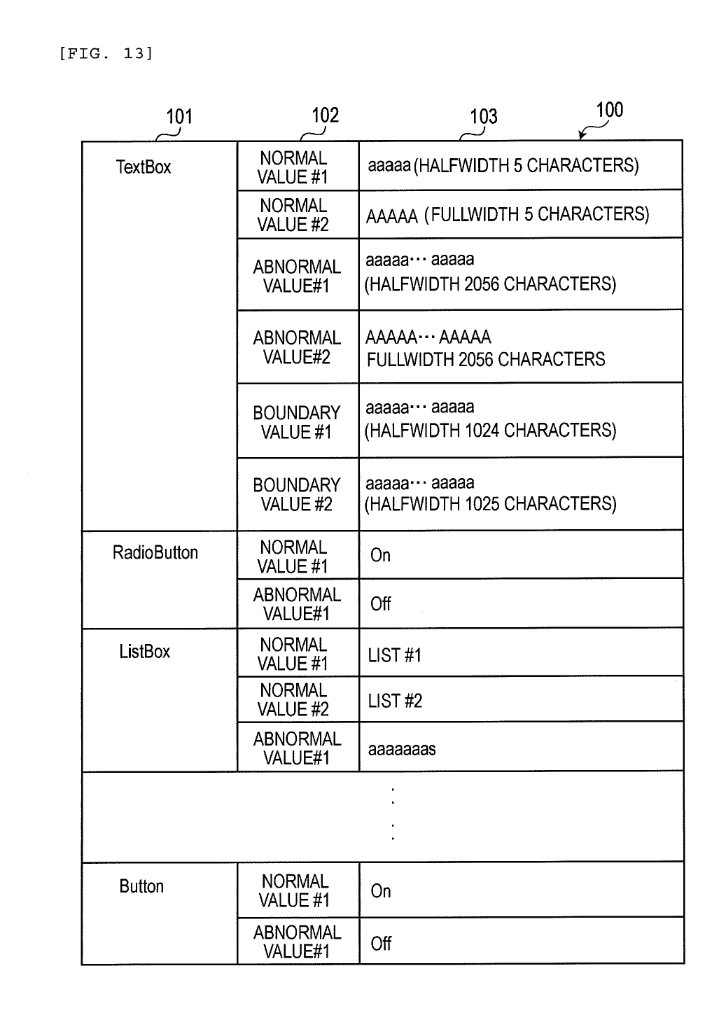

FIG. 12A is a flowchart showing processing to generate a test case according to the embodiment of the invention.

FIG. 12A is a flowchart showing the sequence process 540 of FIG. 9.

After finishing the processing shown in FIG. 11, the automatic test case generation unit 60 starts the processing shown in FIG. 12A (980). The automatic test case generation unit 60 then acquires one form, of the forms extracted in the step 960 (990).

The automatic test case generation unit 60 generates a test case corresponding to the one form acquired in the step 990, based on the test case definition file 100 (1000). The test case definition file 100 will be described in detail later with reference to FIG. 13.

After the step 1000, the automatic test case generation unit 60 determines whether or not there is a form with which the processing of the step 1000 is not executed yet, of the forms extracted in the step 960 (1080). If there is a form with which the processing of the step 1000 is not executed yet, the automatic test case generation unit 60 returns to the step 990.

By the step 1080, a test case corresponding to a web content that is updated by addition or change is generated.

If there is no form with which the processing of the step 1000 is not executed yet and all the forms extracted in the step 960 are already processed, the automatic test case generation unit 60 shifts to a step 1090. In the step 1090, the automatic test case generation unit 60 determines whether the operation log corresponding to the common part between the web content before update and the web content after update is stored in the temporary storage area provided in the main storage unit 20 or not. That is, the automatic test case generation unit 60 determines whether the operation log is generated in the step 940 shown in FIG. 11 or not.

If it is determined in the step 1090 that the operation log corresponding to the common part between the web content before update and the web content after update is not stored in the temporary storage area, the entire web content after update is a web content that is added or changed. Therefore, the automatic test case generation unit 60 generates only an operation log corresponding to the test case generated in the step 1000 and thus acquires an operation log corresponding to the web content after update (1110).

If it is determined in the step 1090 that the operation log corresponding to the common part between the web content before update and the web content after update is stored in the temporary storage area, the automatic test case generation unit 60 acquires the operation log corresponding to the common part from the temporary storage area provided in the main storage unit 20 or the like (1100).

After the step 1100, the automatic test case generation unit 60 generates an operation log corresponding to the test case generated in the step 1000. Then, the generated operation log is connected to, that is, added to or inserted into, the operation log corresponding to the common part, and an operation log corresponding to the web content after update is thus generated (1120).

After the step 1110 or the step 1120, the automatic test case generation unit 60 extracts the test case corresponding to the generated operation log and transmits the extracted test case to the client device 200 (1125). Also, in the step 1125, the automatic test case generation unit 60 acquires the test case modification script 90 from the auxiliary storage unit 30. The automatic test case generation unit 60 then adds the test case modification script 90 and the information indicating the web content to the test case and transmits the resulting information to the client device 200.

After the step 1125, the processing shown in FIG. 12A ends (1130).

By the processing shown in FIG. 12A, a test case and an operation log corresponding to a web content after update can be generated.

FIG. 12B is a flowchart showing processing to generate a test case according to the embodiment of the invention. FIG. 12B is equivalent to the step 1000 of FIG. 12A.

After the step 990, the automatic test case generation unit 60 starts the processing shown in FIG. 12B (1001). First, the automatic test case generation unit 60 determines the type of the one form acquired in the step 990 (1005).

For example, if the type of the form is a text box, the automatic test case generation unit 60 generates a test case where a normal value is entered in the text box (1010). The automatic test case generation unit 60 also generates a test case where an abnormal value is entered in the text box (1040) and a test case where a boundary value is entered in the text box (1070).

Alternatively, for example, if the type of the form is radio button, the automatic test case generation unit 60 generates a test case where a normal value is entered in the radio button (1020) and a test case where an abnormal value is entered in the radio button (1050).

Meanwhile, if the type of the form is a button, the automatic test case generation unit 60 generates a test case where a normal value is entered in the button (1030) and a test case where an abnormal value is entered in the button (1060).

After generating the test case corresponding to each form, the automatic test case generation unit 60 ends the processing shown in FIG. 12B (1075) and shifts to the step 1080 shown in FIG. 12A.

The server device 10 holds the test case definition file 100 to generate a test case corresponding to each form, using the auxiliary storage unit 30. In the test case definition file 100, test cases to be generated are described in advance according to the type of form. In the step 1000 of FIG. 12B, the automatic test case generation unit 60 generates a test case for each form, referring to the test case definition file 100.

FIG. 13 is an explanatory view showing the test case definition file 100 according to the embodiment of the invention.

The test case definition file 100 includes sections of form 101, condition 102 andvalue 103. The test case definition file 100 is created in advance by the test performer, manager or the like. The created test case definition file 100 is stored in the server device 10.

The form 101 indicates the type of form, for example, text box, radio buttons, list box, button or the like. The condition 102 shows the type of a value that can be entered when an operation is done in each form 101. For example, if the form 101 is a text box, the value that can be entered in the text box is one of a normal value, abnormal value and a boundary value.

The value 103 shows a specific value corresponding to each condition 102 of each form 101. For example, in the text box of this embodiment, up to 1024 halfwidth characters can be entered. Therefore, if the form 101 is a text box and the condition 102 is a normal value, a value equivalent to 1023 characters or less is written in the value 103.

Alternatively, if the form 101 is a text box and the condition 102 is a boundary value, values equivalent to 1024 characters and 1025 characters are stored. Also, if the condition 102 is an abnormal value, a value equivalent to 1026 characters or more is stored.

Meanwhile, for example, with the radio buttons of this embodiment, if no radio button is designated and the radio buttons are “Off”, an error is outputted. Therefore, if the form 101 is radio buttons and the condition 102 is a normal value, “On” is stored in the value 103. If the condition 102 is an abnormal value, “Off” is stored in the value 103.

Also, for example, in the list box of this embodiment, if a value that is not a predetermined list value (LIST#1, LIST#2) is designated, an error is outputted. Therefore, if the form 101 is a list box and the condition 102 is a normal value, “LIST#1” or “LIST#2” is stored in the value 103. If the condition 102 is an abnormal value, a character string that is not “LIST#1” or “LIST#2” is stored in the value 103.

The automatic test case generation unit 60 lists the value 103 corresponding to each form, using the test case definition file 100, and thus generates test cases.

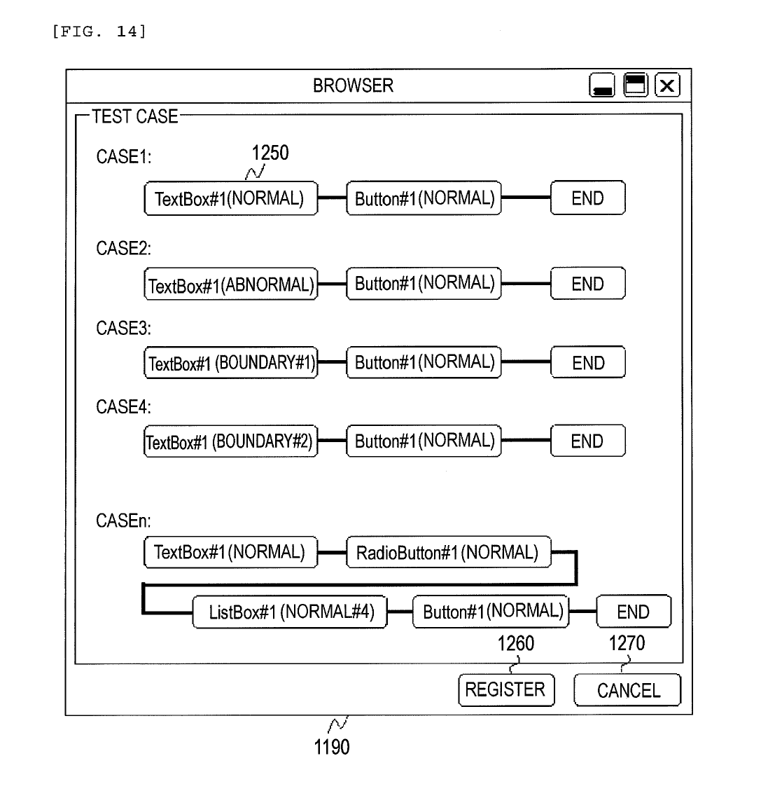

FIG. 14 is an explanatory view showing a screen 1190 to modify a test case according to the embodiment of the invention.

FIG. 14 shows the screen 1190 displayed on the web browser 260 in order to allow the test performer to check each test case sent from the server device 10. The screen 1190 is displayed in the sequence process 560 shown in FIG. 9.

The web browser 260 displays an icon 1250 shown in FIG. 14 indicating each condition of each form and thus shows the test case generated in the sequence process 550 shown in FIG. 9 to the test performer.

For example, a CASE 1 shown in FIG. 14 is a test case where a normal value is entered in a text box form, subsequently a normal value is entered in a button form, and then the test ends. Also, a CASE n shown in FIG. 14 is a test case where a normal value is entered in a text box form, subsequently a normal value is entered in a radio button form, a normal value is entered in a list box form, a normal value is entered in a button form, and then the test case ends.

If there is a test case that the test performer wants to modify, from among the test cases, the test performer operates the icon 1250 indicating the form of the test case to be modified and modifies the test case. Then, after modifying the test case, the test performer operates a registration button 1260. Thus, the client device 200 transmits the modified test case and a request to store the modified test case to the server device 10 (equivalent to the sequence process 570 of FIG. 9). The icon 1250 and the registration button 1260 are operated as these buttons are clicked on or the like.

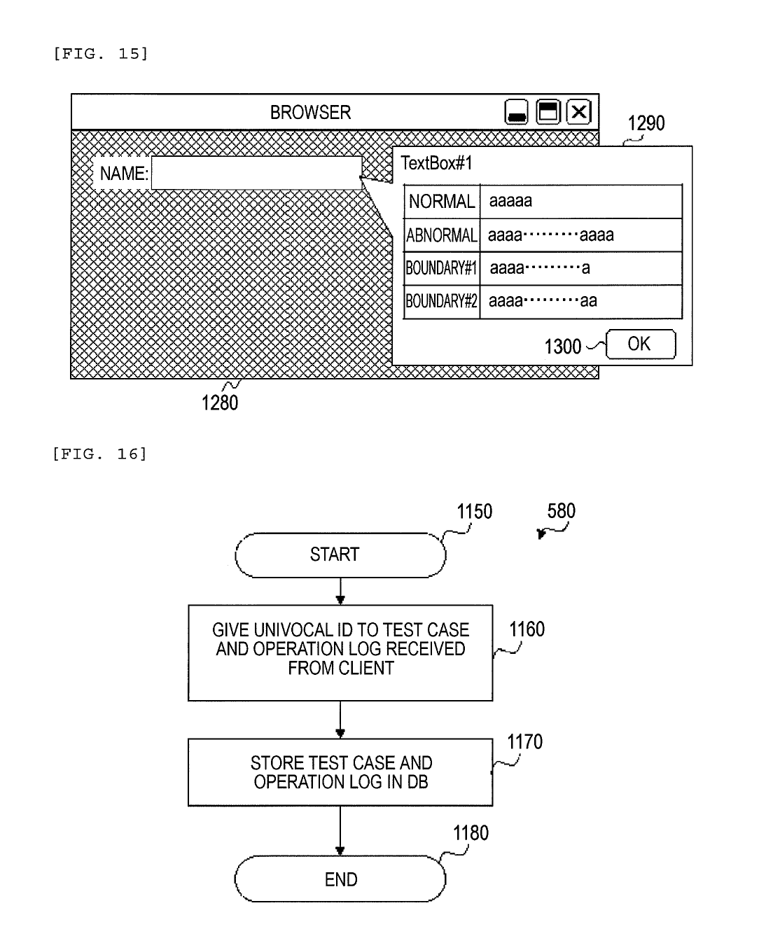

FIG. 15 is an explanatory view showing a screen 1280 to modify a value of a test case according to the embodiment of the invention.

FIG. 15 shows the screen 1280 displayed on the web browser 260 so that the test performer can modify a value of each test case sent from the server device 10.

If the test performer wants to modify the value related to the text box form of the CASE 1 on the screen 1190 shown in FIG. 14, the test performer operates the icon 1250 indicating the text box form of the CASE 1. After that, the screen 1280 shown in FIG. 15 is displayed on the web browser 260.

On the screen 1280, only the area of the form corresponding to the icon 1250 operated in FIG. 14 is displayed, of the screen displayed by the web content. The other areas are masked or devised otherwise so that the test performer cannot select these areas.

When the test performer selects the text box displayed on the screen 1280, a screen 1290 to modify a value to test the text box is displayed. The test performer modifies the value corresponding to each condition and operates an OK button 1300, thus deciding the content of modification. The OK button 1300 is operated as this button is clicked on or the like.

The screen 1190 and the screen 1280 to modify a test case are not limited to the display method shown in FIGS. 14 and 15 and can be univocally designated for each form of the test case. Any display method that enables change of a value may be employed.

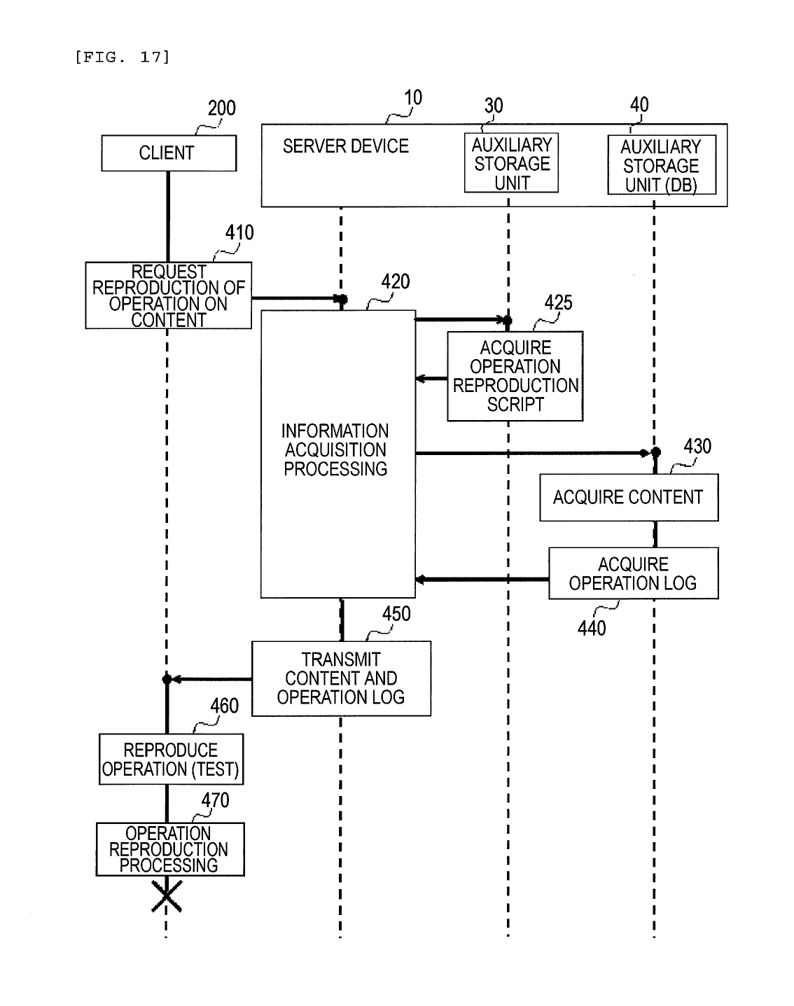

FIG. 16 is a flowchart showing processing to store a test case and an operation log modified by the client device 200 according to the embodiment of the invention.

FIG. 16 shows processing to store, in the server device 10, a test case and the operation log 300 modified via the web browser 260 and the test case modification script unit 280 provided in the client device 200. The processing shown in FIG. 16 is equivalent to the sequence process 580 shown in FIG. 9.

When the server device 10 receives a requests to store a test case modified by the client device 200, the server device 10 starts the processing shown in FIG. 16 (1150). The server device 10 gives a univocal identifier to the test case received from the client device 200 and the operation log generated from the test case (1160).

Then, the server device 10 stores the operation log sent from the client device 200 into the operation log 150 of the auxiliary storage unit 40 (1170). After that, the server device 10 ends the processing shown in FIG. 16.

### (Operation Reproduction Processing)

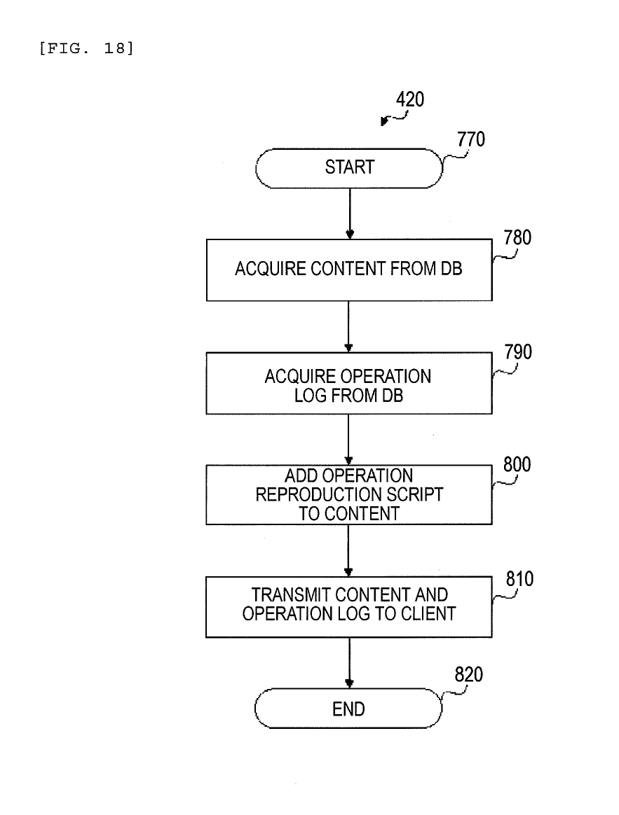

FIG. 17 is a sequence diagram showing processing to reproduce the web content 140 held in the server device 10 and the operation log 150 corresponding to the web content 140, in the client device 200 according to the embodiment of the invention.

When the test performer reproduces an operation that is carried out in the past at the time of executing a web content on the web browser 260, or when the test performer tests a web content using a test case that is automatically generated by the server device 10, the client device 200 first transmits a request to reproduce the operation of the web content to the server device 10 (410).

In the sequence process 410, the client device 200 transmits the request to reproduce the operation of the web content and information indicating the web content 140 corresponding to the requested web content. The information indicating the web content 140 is held in advance in the client device 200 by the processing shown in FIGS. 4 and 9.

After the server device 10 receives the request to reproduce the operation of the specific web content and the information indicating the web content 140 corresponding to the requested web content via the HTTP server unit 80 and the application server unit 70 as described above (420), the operation recording/operation reproduction script embedding unit 50 acquires the operation reproduction script 130 held in the auxiliary storage unit 30 (425).

The operation recording/operation reproduction script embedding unit 50 also acquires the web content 140 held in the auxiliary storage unit 40 and the operation log 150 corresponding to the web content 140, based on the received information (430, 440). Then, the acquired operation reproduction script 130, web content 140 and operation log 150 are transmitted to the client device 200 via the application server unit 70 and the HTTP server unit 80.

In the sequence processes 430 and 440, if the information indicating the web content sent from the client device 200 is an identifier, the operation recording/operation reproduction script embedding unit 50 acquires the web content 140 and the operation log 150 based on the identifier. Meanwhile, if the information indicating the web content sent from the client device 200 is a file name or the like, the operation recording/operation reproduction script embedding unit 50 acquires the web content 140 and the operation log 150 of a version that is predetermined by the manager or the like, such as the latest version.

After the operation reproduction script 130, the web content 140 and the operation log 150 are transmitted to the client device 200 from the server device 10, the client device 200 stores the transmitted web content 140 in the web content 290 and stores the transmitted operation log 150 in the operation log 300. Then, the newly stored web content 290 is executed by the operation recording/operation reproduction script unit 270 (460). The operation recording/operation reproduction script unit 270 executes the newly stored web content 290 and the newly stored operation log 300 is sequentially executed by the operation reproduction script 130, thus reproducing the operation (470).

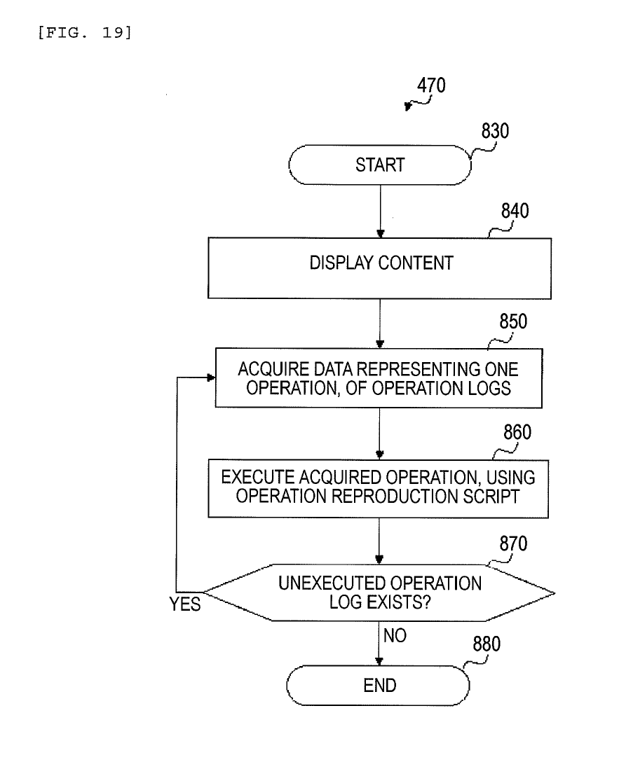

FIG. 18 is a flowchart showing processing to acquire information to reproduce an operation according to the embodiment of the invention.

The processing shown in FIG. 18 is the processing shown in the sequence process 420 of FIG. 17. FIG. 18 shows processing to acquire, from the auxiliary storage unit 40, the web content 140 that is a subject of operation reproduction and the operation log 150 corresponding to the web content 140 requested by the client device 200 and transmit the web content 140 and the operation log 150 to the client device 200.

After the request to reproduce the operation of the web content and the identifier indicating the web content 140 corresponding to that web content are transmitted to the server device 10 from the client device 200, the server device 10 starts the processing shown in FIG. 18 (770). After the step 770, the operation recording/operation reproduction script embedding unit 50 acquires the web content 140 and the operation log 150 corresponding to the web content 140, referring to the auxiliary storage unit 40, based on the information indicating the web content 140 transmitted from the client device 200 (780, 790).

The operation recording/operation reproduction script embedding unit 50 then acquires the operation reproduction script 130 held in the auxiliary storage unit 30 and adds the operation reproduction script 130 to the web content 140 acquired in the step 780, in order to reproduce the web content 140 in the client device 200 (800). The operation recording/operation reproduction script embedding unit 50 then transmits the web content 140 and the operation log 150 to the client device 200 (810) and ends the processing.

The steps 780 and 790 are equivalent to the sequence processes 430 and 440 shown in FIG. 17.

FIG. 19 is a flowchart showing processing to reproduce an operation according to the embodiment of the invention.

FIG. 19 shows the processing of the sequence process 470 of FIG. 17. FIG. 19 shows processing to reproduce the web content 140 and the operation log 150 corresponding to the web content 140 acquired by the server device 10, in the client device 200.

The client device 200 executes the web content 140 sent from the server device 10, using the operation recording/operation reproduction script unit 270, and causes the web browser 260 to display a screen of the web content 140 (840). The operation recording/operation reproduction script unit 270 then acquires data representing one operation of the operation logs 150 sent from the server device 10 (850) and causes the operation reproduction script 130 inserted in the web content 140 to execute the acquired operation (860).

Moreover, after the step 860, the operation recording/operation reproduction script unit 270 determines whether an unexecuted operation log is included in the operation logs 150 sent from the server device 10 or not (870). If an unexecuted operation log is included, the operation recording/operation reproduction script unit 270 returns to the step 850. If an unexecuted operation log is not included and all the operation logs 150 are executed, the server device 10 ends the processing to reproduce an operation (880).

In this embodiment, operation log and test case are distinguished from each other, as described above. However, the client device 200 and the server device 10 may hold either one of operation log and test case.

For example, in the sequence process 390 of FIG. 4, the server device 10 may extract a test case from the operation log 300 sent from the client device 200 and hold the extracted test case. In the sequence process 540 of FIG. 9, the server device 10 may extract a test case corresponding to a common part between web contents before and after update and connect the test case corresponding to the common part with a test case corresponding to a different part.

As described above, according to the embodiment, a test case to test a web content can automatically be generated based on an operation log(script file) used in a past test or the like. Moreover, since a test can automatically be reproduced, the number of processes for testing can be reduced. Also, since a test case can automatically be generated based on a test case definition file that is created in advance, omission of any test case can be prevented. Thus, improved quality of web contents is expected.

The invention is described in detail above with reference to the accompanying drawings. However, the invention is not limited the specific configurations as described above and includes various changes and equivalent configurations that fall within the scope of the invention described in the attached claims.

### INDUSTRIAL APPLICABILITY

The invention can be applied to a system for developing a web application.

1. A test scenario generation method for a computer which holds, in a storage medium, a web content and a test scenario to operate the web content, the method comprising:
causing the computer to extract a common part and a different part between a first web content before update held in the storage medium and a second web content after update;
causing the computer to extract a test scenario corresponding to the common part, of a first test scenario to operate the first web content, from the storage medium in which the first test scenario is stored; and
causing the computer to connect the test scenario corresponding to the extracted common part and a newly generated test scenario corresponding to the extracted different part and thus generate a second test scenario to operate the second web content.

2. The test scenario generation method according to claim 1, including:
causing the computer to include a web content added to the first web content, of the second web content, into the different part; and
causing the computer not to include a web content that is not included in the second web content, of the first web content, into the different part.

3. The test scenario generation method according to claim 1, including:
causing the computer to acquire the second web content; and
causing the computer to extract the first web content and the first test scenario to operate the first web content, of the web content held in the storage medium based on the acquired second web content.

4. The test scenario generation method according to claim 1, including:
causing the computer to determine whether the common part between the first web content and the second web content is extracted or not;
if the common part is not extracted, causing the computer to newly generate a test scenario corresponding to the extracted different part, as the second test scenario; and
if the common part is extracted, causing the computer to connect the test scenario corresponding to the extracted common part and a newly generated test scenario corresponding to the different part and thus generate the second test scenario.

5. The test scenario generation method according to claim 1, wherein
the test scenario includes at least one test case,
the computer holds the test case corresponding to a form included in the web content, and
the method includes:
causing the computer to acquire the test case corresponding to a form included in the different part; and
causing the computer to generate the test scenario including the acquired test case and thus generate a test scenario corresponding to the different part.

6. The test scenario generation method according to claim 1, wherein
the computer holds a designation file to operate the web content using the test scenario, and
the method includes:
causing the computer to add the designation file for operation to the web content; and
causing the computer to transmit the second web content to which the designation file for operation is added and a test scenario to operate the second web content.

7. The test scenario generation method according to claim 1, including:
causing the computer to provide data for displaying a screen to modify the test scenario;
causing the computer to acquire the test scenario modified via the screen; and
causing the computer to hold the test scenario modified via the screen.

8. The test scenario generation method according to claim 1, wherein
the computer holds a designation file to modify the test scenario, and
the method includes:
causing the computer to add the designation file for modification and the test scenario to the second web content; and
causing the computer to transmit the second web content to which the designation file for modification is added and a test scenario to operate the second web content.

9. A test scenario generation system comprising a server which holds a web content and a test scenario to operate the web content, wherein
the server
extracts a common part and a different part between a first web content before update and a second web content after update,
extracts a test scenario corresponding to the common part, of a first test scenario to operate the first web content, and
connects the test scenario corresponding to the extracted common part and a newly generated test scenario corresponding to the extracted different part and thus generates a second test scenario to operate the second web content.

10. The test scenario generation system according to claim 9, wherein the server
includes a web content added to the first web content, of the second web content, into the different part, and
does not include a web content that is not included in the second web content, of the first web content, into the different part.

11. The test scenario generation system according to claim 9, wherein the server
is connected to a client which executes the web content,
acquires the second web content from the client, and
extracts the first web content and the first test scenario to operate the first web content, of the web content held in the server, based on the acquired second web content.

12. The test scenario generation system according to claim 9, wherein the server
determines whether the common part between the first web content and the second web content is extracted or not,
if the common part is not extracted, newly generates a test scenario corresponding to the extracted different part, as the second test scenario, and
if the common part is extracted, connects the test scenario corresponding to the extracted common part and a newly generated test scenario corresponding to the different part and thus generates the second test scenario.

13. The test scenario generation system according to claim 9, wherein
the test scenario includes at least one test case,
the server holds the test case corresponding to a form included in the web content,
acquires the test case corresponding to a form included in the different part, and
generates the test scenario including the acquired test case and thus generates a test scenario corresponding to the different part.

14. Non-transitory computer readable medium storing a test scenario generation program executed by a computer which holds a web content and a test scenario to operate the web content, wherein the program
causes the computer to extract a common part and a different part between a first web content before update and a second web content after update,
causes the computer to extract a test scenario corresponding to the common part, of a first test scenario to operate the first web content, and
causes the computer to connect the test scenario corresponding to the extracted common part and a newly generated test scenario corresponding to the extracted different part and thus generate a second test scenario to operate the second web content.
